(19) United States
(12) Patent Application Publication
(10) Pub. No.: US 2017/0197537 A1
(43) Pub. Date: Jul. 13, 2017

(54) MURPHY BED ASSEMBLY

(71) Applicant: Coach House, Inc., Nokomis, FL (US)

(72) Inventors: David R. Gerzeny, Nokomis, FL (US); Matthew L. Gerzeny, Nokomis, FL (US); Steven B. Gerzeny, Nokomis, FL (US)

(21) Appl. No.: 14/991,088

(22) Filed: Jan. 8, 2016

(51) Int. Cl. B60P 3/34; A47C 17/80

(52) U.S. Cl. CPC B60P 3/34; A47C 17/80

(57) ABSTRACT

A Murphy bed assembly for a motorhome which is actuated hydraulically from a stored position in which the bed is vertically positioned within the space provided by an extension formed in the motorhome to a horizontal position extending into the interior of the motorhome.

### FIELD OF THE INVENTION

The present invention is directed to Murphy bed assembly and more particularly to a hydraulically operated Murphy bed assembly for a motorhome.

### BACKGROUND OF THE INVENTION

Motorhomes are generally of limited space and generally providing beds in such vehicles presents a problem of utilizing space that could be used for other requirements and/or amenities. Motorhomes have been provided in the past with Murphy beds or other beds capable of being stored in the walls or other areas of the motorhome out of the way until ready for use. Generally these beds have been difficult to maneuver from the stored position to the position of use and then as difficult to place back in the stored position.

### SUMMARY OF THE INVENTION

The present invention provides a construction in which a bed can be stored within a side extension of a motorhome. Side extensions are commonly provided for motorhomes to provide additional interior space for the motorhome. In the present invention the extension is fixed to the side of the motorhome and opens to the interior of the motorhome. A Murphy bed assembly is provided to fit within the space provided by the side extension including the bed and the mechanism for actuating the bed from a stored position to a position of use. The mechanism is in the form of hydraulically actuated cylinders which move the bed between the positions so that the requirement of physically moving the bed is eliminated.

### BRIEF DESCRIPTION OF THE DRAWING

A better understanding of the present invention can be had by referring to the drawings included with this application in which

FIG. 1 is as side perspective view of a motorhome with an extended side which houses the Murphy Bed Assembly of the present invention;

FIG. 2A is diagrammatic view partially in cross section taken at line 2A-2A of FIG. 1 illustrating the Murphy Bed assembly in elevation and in a storage position;

FIGS. 2B-2F are diagrammatic views taken along 2B-2B through 2F-2F of FIG. 1 partially in cross section and illustrating the Murphy Bed in various positions between a storage position and a ready position;

FIG. 3 is a cross sectional view taken substantially along line 3-3 of FIG. 2A;

FIGS. 3A and 3B are views of sections of FIG. 3 enlarged for clarity;

FIG. 4A an exploded view of a portion of the Murphy Bed Assembly of the present invention;

FIG. 4B is an elevational view of the parts shown in FIG. 4A in an assembled condition; and

FIG. 4C is an enlarged view of the section 4C-4C in FIG. 4B.

### DETAILED DESCRIPTION OF THE PREFERRED EMBODIMENT

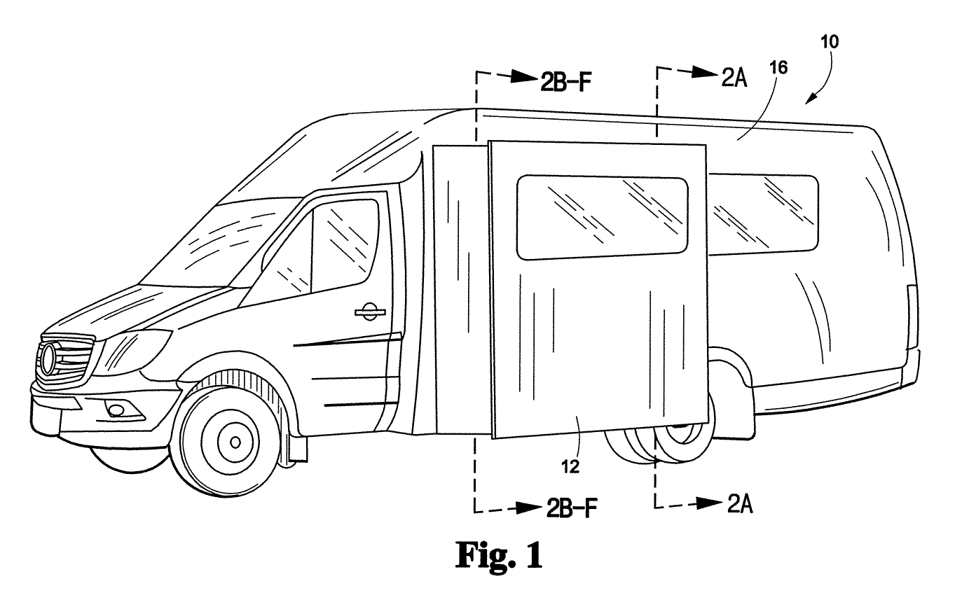

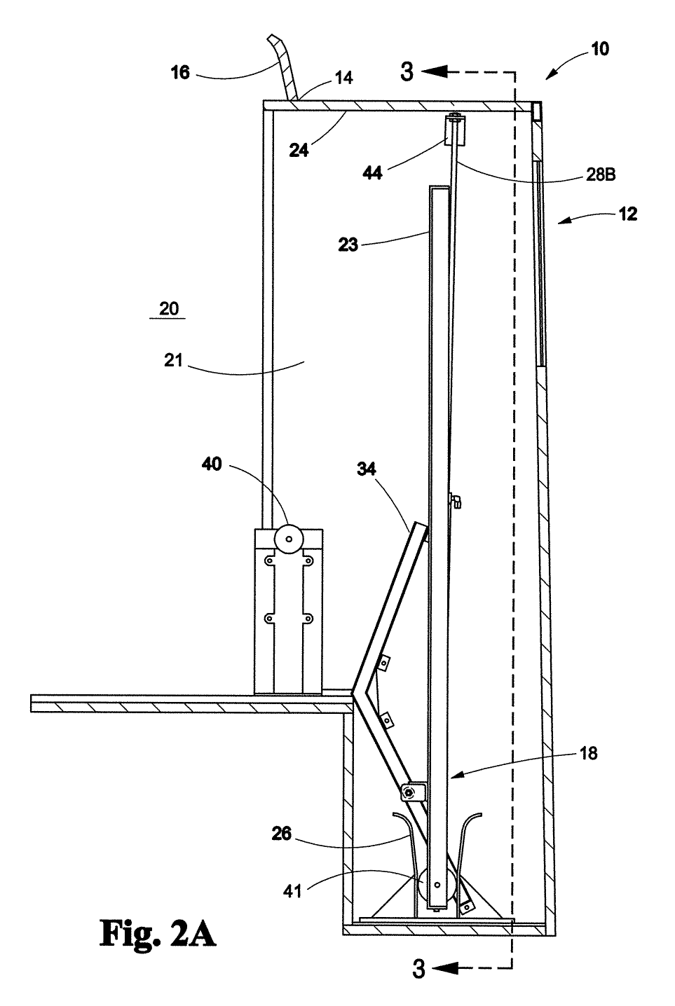

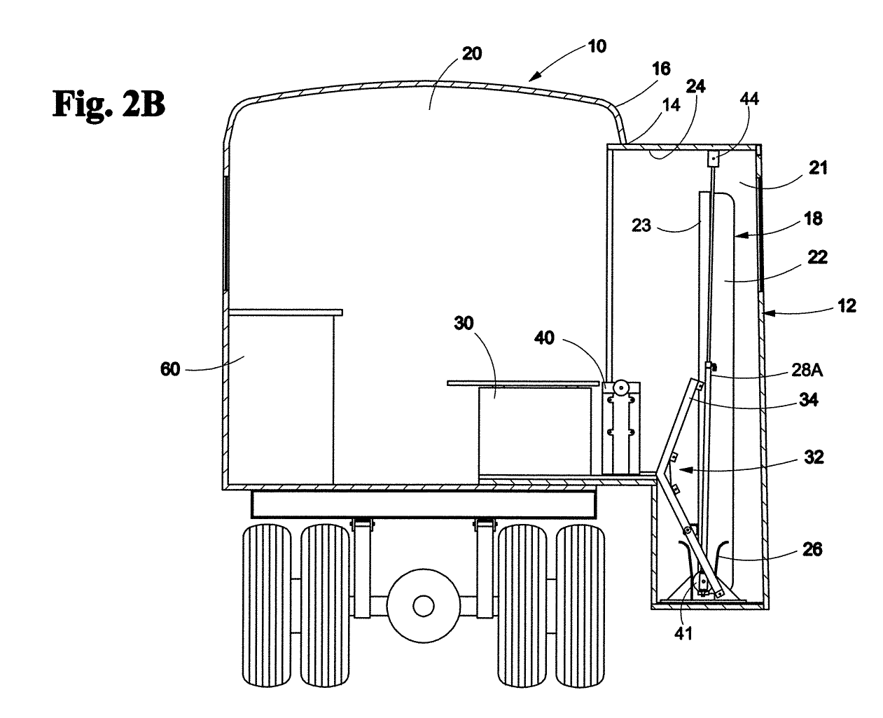

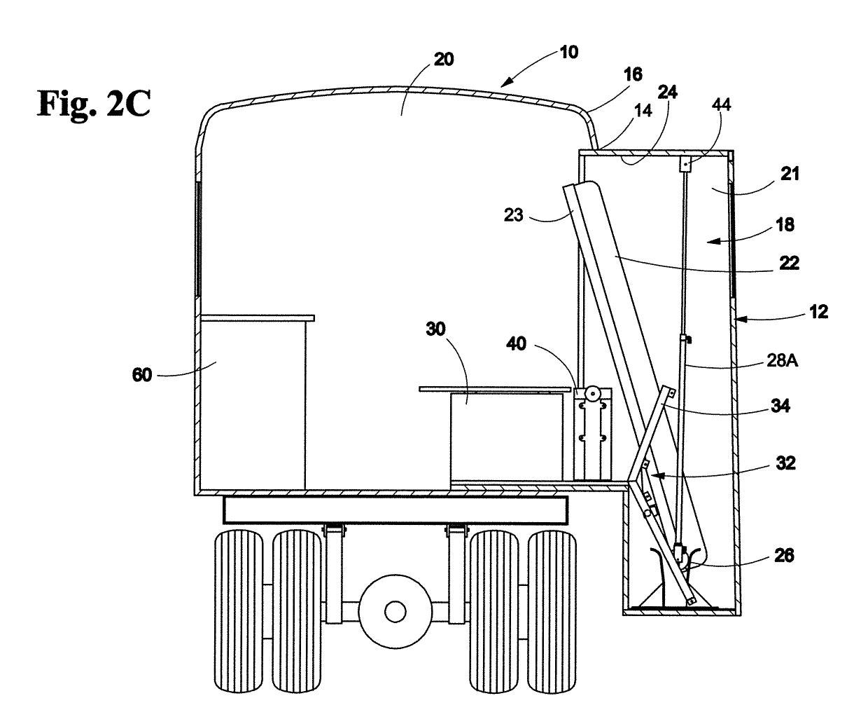

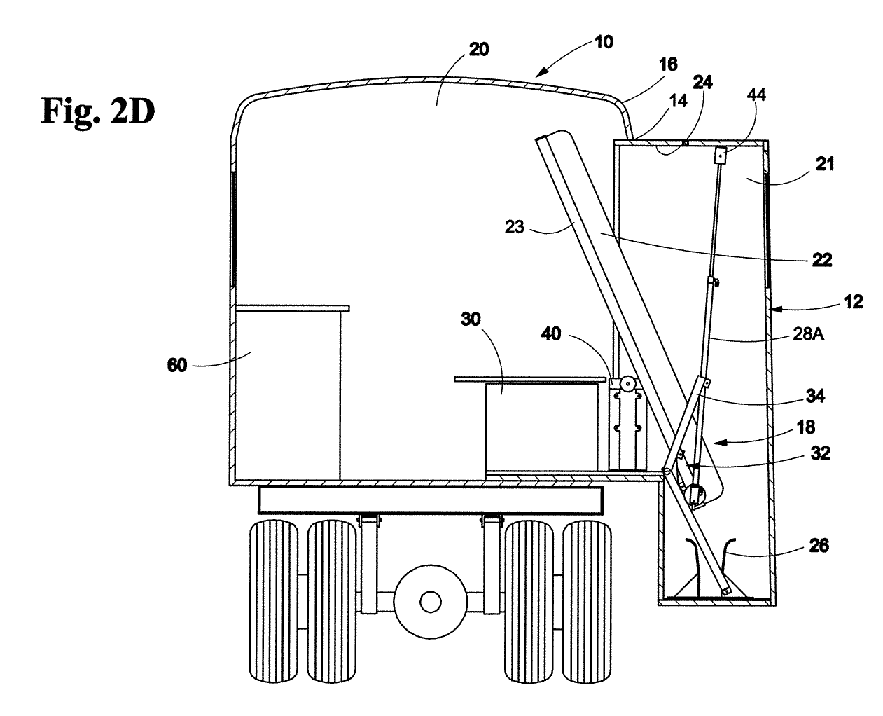

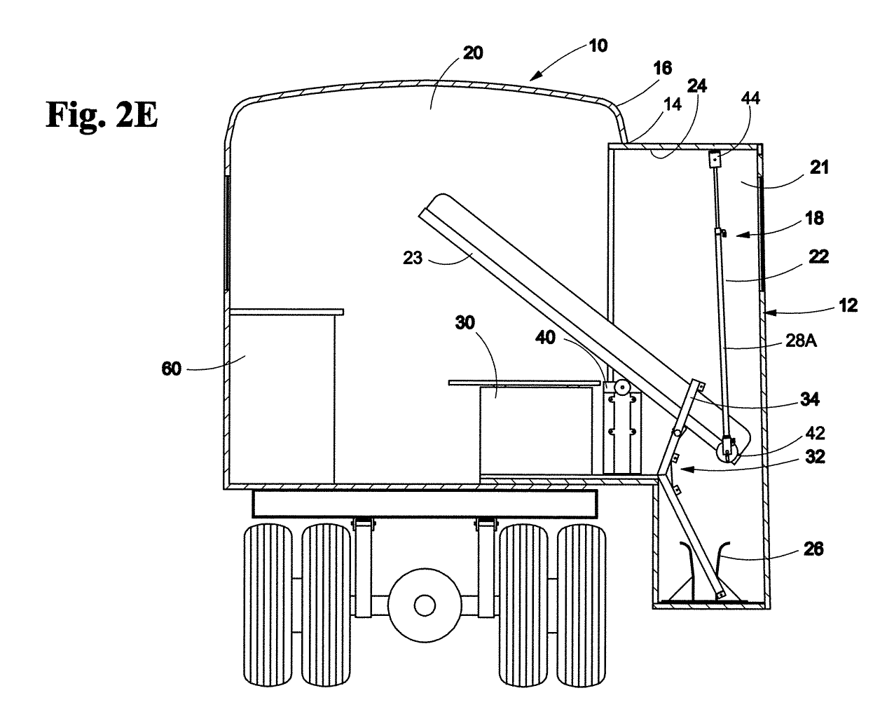

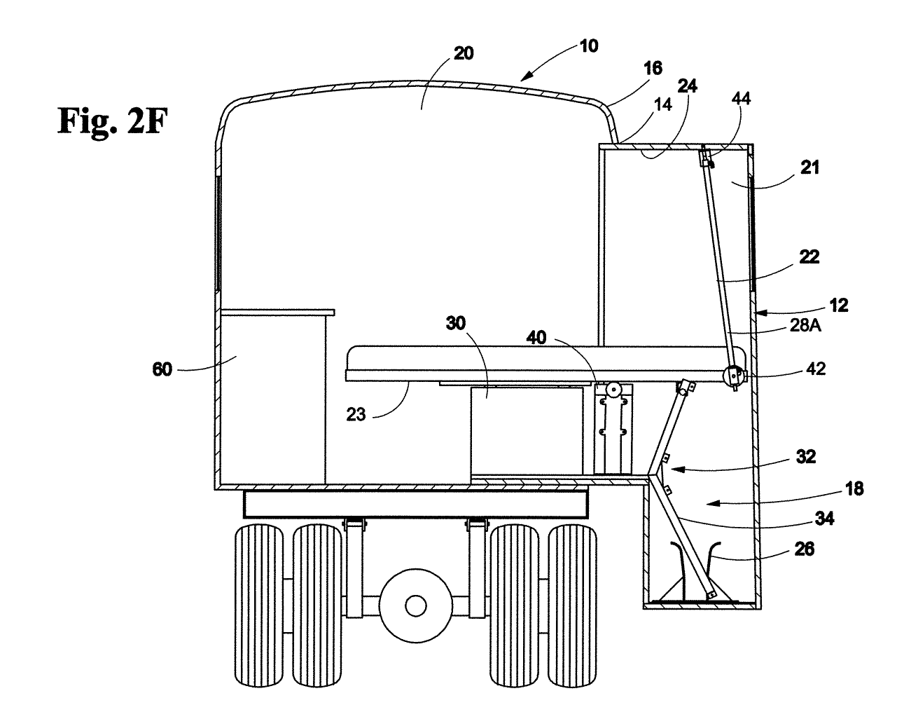

As can best be seen in FIG. 1 a motorhome 10 is provided with a side extension 12 which is shown in FIG. 2A as fitting within an opening 14 formed in the motorhome housing 16. The side extension 12 is closed to the exterior of the motorhome 10 but opens to the interior 20 of the motorhome 10 through the opening 14. A Murphy bed assembly 18 is disposed within the interior 21 of the side extension 12 and includes a bed 22 mounted to a frame 23 shown in FIG. 2B in the stored position. One edge of the bed 22 fits within a cradle 26 when the bed 22 is in the stored position.

FIG. 2C shows the bed 22 tipped and the top of the bed 22 clearing the ceiling 24 of the side extension 12 and extending partially into the interior 20 of the motorhome 10. The assembly includes hydraulic cylinder 28A-28B mounted on each side of the bed 22 and between the ceiling 24 of the extension 12 and the bed frame 23 and operable upon being actuated to move the bed 22 upwardly past the opening 14 first to the position shown in FIG. 2E and then to the position shown in 2F atop a support 30 ready to be used.

The actuating system for moving the bed 22 from the vertically extending storage position to the horizontal position shown in FIG. 2F includes cylinders 28A and 28B with one on each side of the bed 22 and each mounted between the ceiling 24 by a bracket 44 and the bed frame 23.

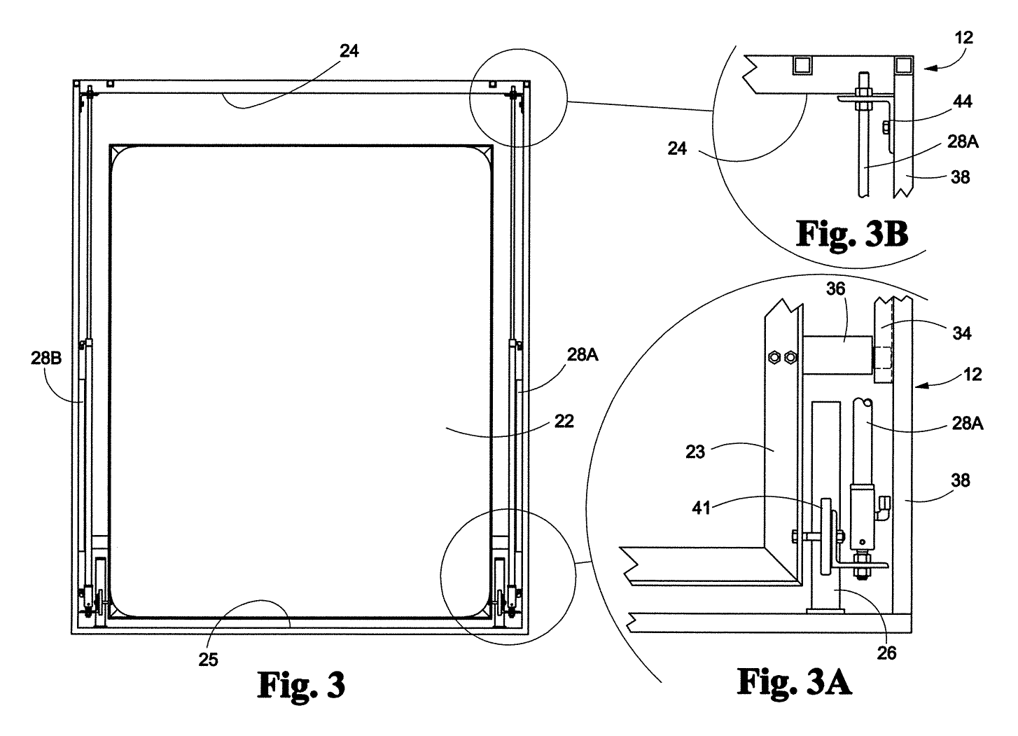

FIG. 3 illustrates cylinders 28A and 28B on opposite sides of the bed 22 attached to the ceiling 24 by brackets 44 with the lower end of the cylinders 28A and 28B connected to the bed frame through a roller 41. Retractions of the cylinders 28A and 28B move the bed frame 23 upwardly. The roller 41 aids in moving the bed frame 23 out of cradle 28 and to the horizontal position shown in FIG. 2F.

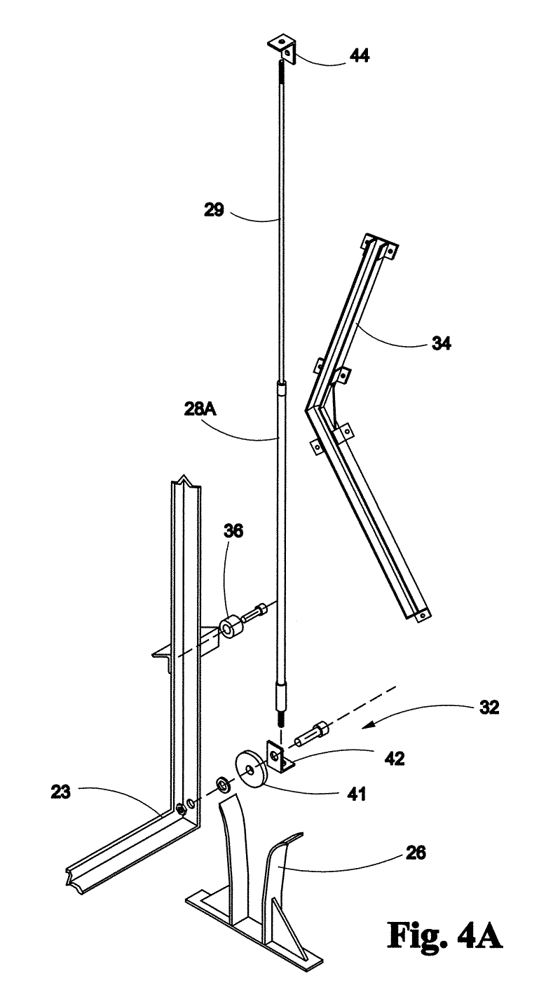

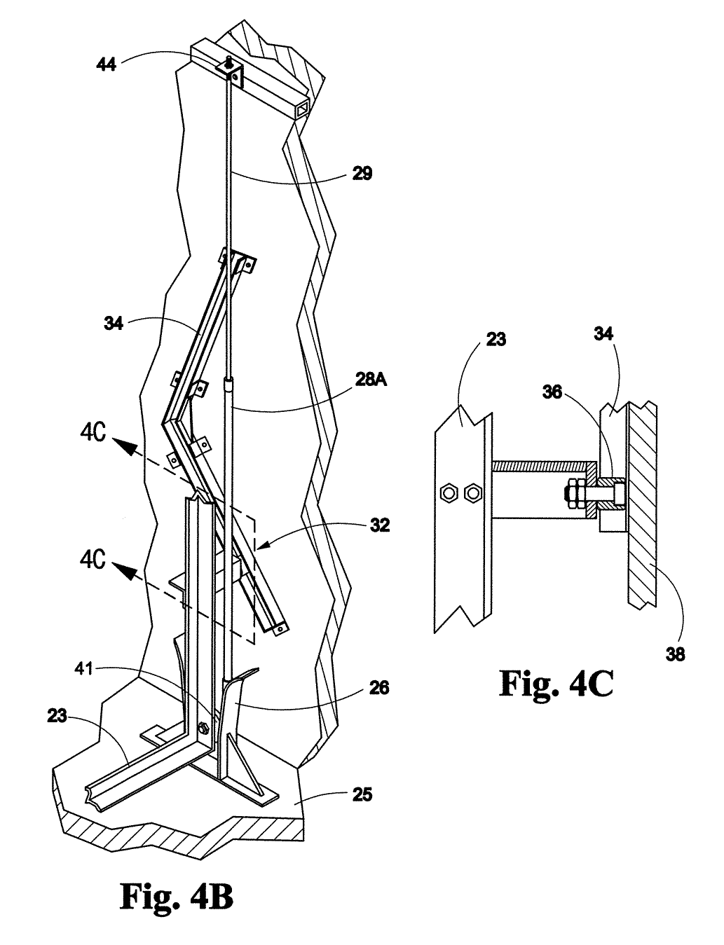

As can best seen in FIGS. 2A and 2b there is a cam assembly 32 on each side of the bed 22 with each cam assembly 32 causing directed upward movement of the bed 22 upon retraction of the cylinders 28A and 28B. Referring to FIGS. 4A and 4B each cam assembly 32 includes a cam roller 36 attached to the bed frame 23 and a cam track 34 attached to the sidewall 38 of the extension 20 with the cam roller 36 fitting within the track 34 to roll along within the track 38 as the bed 22 is moved. The track 34 is angled so that for the initial upward movement the bed 22 is moved from the position shown in FIG. 2B toward the position shown in FIG. 2C where the upper edge of the bed clears the ceiling 24 of the extension 12 and the opening 14. Further upward movement the bed 22 as caused by further retraction of the cylinders 28A, 28B causes the roller 36 to roll in the outwardly angled portion 35 of the cam track 34 to move the upper edge further into the interior of the motorhome 10 toward the position shown in FIG. 2E. In the position shown in FIG. 2E the bottom of the bed frame 23 engages a roller 40 to aid in moving the bed 22 toward a horizontal position. Further retraction of the cylinders 28A, 28B causes, in conjunction the cam assembly 32, retraction of the cylinder 28A, 28B to move the bed 22 toward the position shown in FIG. 2F. In the horizontal position shown in FIG. 2F the bed 22 is supported by the roller 40 and a support 30 in a position spaced from furniture 60.

The hydraulic actuating system is preferably connected to the electrical system of the motorhome 10 through a wall switch 50. The switch 50 is used to actuate the pump motor 52 to cause the pump 54 to direct fluid pressure through a manifold 56 to ends 62A,62B of the cylinders 28A,28B to retract the cylinders rods 66A, 66B respectively and to ends 64A,64B to extend the cylinder rods 64A, 64B. Extension of the rods 64A, 64B causes the bed 22 to move to a storage position and retraction of the rods 64A,64B causes the bed 23 to move to the horizontal position within the interior 20 of the motorhome A sync cylinder 58 is provided to synchronize pressure between the cylinders 26A and 26B so that the cylinders act in synchronization as they are extended and retracted.

It should be apparent that a Murphy bed assembly for a motorhome has been described which includes a hydraulic system for easily moving the bed between a stored position and a position to be used.

1. A Murphy Bed assembly for use in a motorhome, said motorhome having an extension formed on the side of the motorhome; said Murphy bed assembly comprising;
a bed and means for moving said bed from a stored, vertical position within said extension to a horizontal position within said motorhome;
said moving means comprising at least one hydraulic cylinder connected to the side of said bed and operable to move end of said bed upwardly upon being actuated;
a cam assembly including a cam roller and a cam track said cam roller fitting within said track; and
said cam roller connected to said bed and said track being dimensioned to cause said bed to move from a vertical position to a horizontal position as said cylinder retracts.

2. The assembly as defined in claim 1 and in which said cam track is dimensioned to cause the upper edge of said bed is initially moved downwardly upon initial retraction of said hydraulic cylinder.

3. The assembly as defined in claim 1 and including a second hydraulic cylinder connected to said bed on the side of said bed opposite said first cylinder.

4. The assembly as defined in claim 1 and including a cam assembly connect to said bed on the side of said bed opposite said first cam assembly

5. The assembly as defined in claim 1 and comprising a second cylinder connected to said bed on the side of said bed opposite to said first mentioned cylinder, a pump connected to said cylinders and a manifold operable to selectively retract and extend said cylinders and a synchronizing cylinder for synchronizing the provision of hydraulic power to said cylinders
